(19) United States
(12) Patent Application Publication
(10) Pub. No.: US 2010/0097629 A1
(43) Pub. Date: Apr. 22, 2010

(54) DOCUMENT CREATING APPARATUS AND PROGRAM USED FOR THE SAME

(75) Inventor: Kazunobu Takahashi, Shizuoka (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/582,340

(22) Filed: Oct. 20, 2009

Related U.S. Application Data
(60) Provisional application No. 61/107,512, filed on Oct. 22, 2008.

(51) Int. Cl. G06K 15/00

(52) U.S. Cl. 358/1.14

(57) ABSTRACT

A document creating apparatus includes a creation unit configured to create electric data, a request unit configured to request an input of a password to the electric data created by the creation unit, a determination unit configured to determine presence or absence of the input of the password according to the request unit, and a setting unit configured to set an arbitrary character string as the password when the determination unit determines that the password is not inputted.

### CROSS REFERENCE TO RELATED APPLICATION

This application claims the benefit of U.S. provisional application No. 61/107,512, filed Oct. 22, 2008.

### TECHNICAL FIELD

The present invention relates to a technique to create an electric data document with a password.

### BACKGROUND

Hitherto, when a user creates a document with a password, such as a secure PDF, by a personal computer, the user generally inputs plural kinds of passwords, such as a password (Owner Pass) for manager, which has no operation restriction on a document and a password (Guest Pass) for a third person, which has operation restriction on a document, at the time of document storage.

However, a creator is required to again input the Owner Pass, Guest Pass, and a password for confirming these. Accordingly, the creator is compelled to input character strings plural times, and this is inconvenient.

On the other hand, when a format of a document

with a password is created by a personal computer, it is necessary to set some password. In this case, there is a case where the user sets a simple password. In the format as stated above, the document with the password has vulnerability such as password leakage.

The present invention provides a document creating apparatus in which while security is kept, a password is efficiently set to a document of electric data.

### SUMMARY

According to one aspect of the present invention, there is provided a document creating apparatus comprising: a creation unit configured to create electric data; a request unit configured to request an input of a password to the electric data created by the creation unit, a determination unit configured to determine presence or absence of the input of the password according to the request unit; and a setting unit configured to set an arbitrary character string as the password when the determination unit determines that the password is not inputted.

### DESCRIPTION OF THE DRAWINGS

FIG. 1 is a block diagram showing a document creating system configuration of an embodiment.

FIG. 2 is a block diagram showing a document creating apparatus of an embodiment.

FIG. 3 is a flowchart showing password setting by the document creating apparatus of the embodiment.

FIG. 4 is a view showing a password input initial setting screen in the document creating apparatus of the embodiment.

FIG. 5 is a view showing a screen requesting password input at the time of document creation in the document creating apparatus of the embodiment.

### DETAILED DESCRIPTION

Hereinafter, a document creating apparatus of an embodiment will be described with reference to the drawings. FIG. 1 is a schematic diagram showing the whole structure of a system of a document creating apparatus. In the drawings, reference numeral 1A, 1B denotes a personal computer as a document creating apparatus; 2, an MFP (Multi Function Peripheral) including a not-shown scanner and printer; and 3, a document management server to store a document file created by the personal computer and an image file read by the scanner of the MFP through a network LAN.

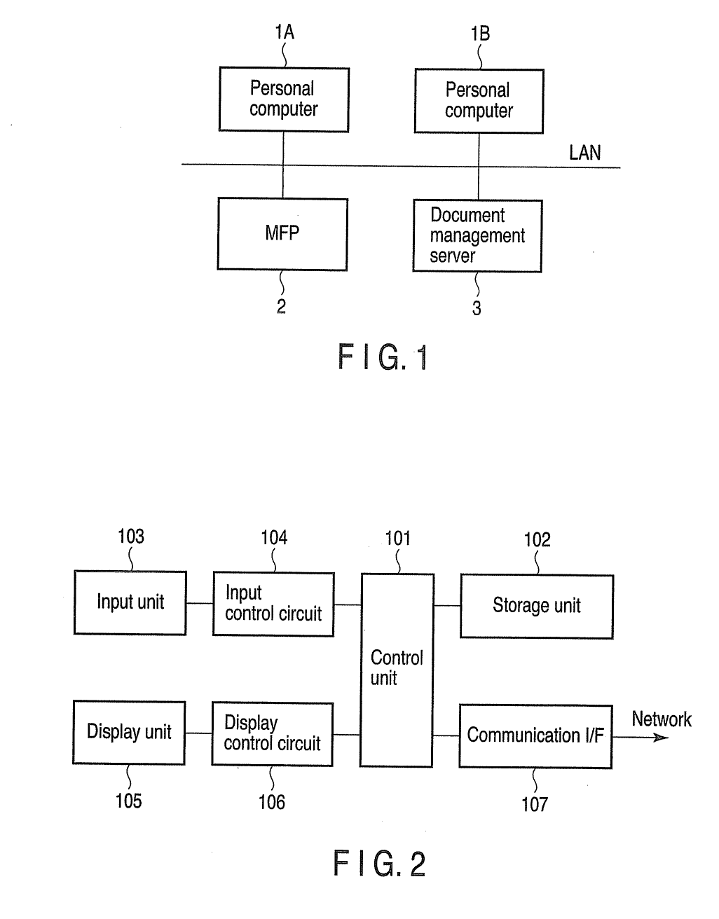

FIG. 2 is a block diagram showing a structure of a document creating apparatus. The document creating apparatus includes a control unit 101, a storage unit 102, an input unit 103, an input control circuit 104, a display unit 105, a display control circuit 106, a communication I/F (Interface) 107, and a communication I/F 108. The control unit 101 controls operations of the respective units of the document creating apparatus. The storage unit 102 is, for example, a HDD (Hard Disk Drive) or a non-volatile memory. The storage unit 102 records various data such as an operation program of the document creating apparatus.

The input unit 103 is, for example, a keyboard. The input unit 103 is used for input of various information or input of operation instructions to the respective units. The input control circuit 104 transmits an input signal to the control unit 101 based on the input of the input unit 103. The display unit 105 is, for example, a monitor. The display unit 105 displays various information such as image data. The display control unit 106 controls a screen display on the display unit 105.

The communication I/F 107 is connected to a network. The communication I/F 107 is connected to, for example, the document management server through the network. The control unit 101 transmits a document created by a document creator to the document management server through the communication I/F 107. The document stored in the document management server can be read by the user using the document creating apparatus connected to the network. The user here includes the creator who creates the document, a manager of the document, and another third person.

Here, a description will be given to a case where the creator creates a document according to a document creation program recorded in the storage unit 102. The document creating program is a format that requests input of a password to a document. The control unit 101 creates the document of electric data according to the input of the keyboard 103 by the creator. The control unit 101 functions as a creation unit of the document of the electric data.

The control unit 101 starts the document program and requests input of a password at the time point when the document is created. The time point when the document is created is, for example, just before the document under creation is first stored in the storage unit 102. The control unit 101 functions as a request unit of input of the password. The document program used here has such a format that unless the password is set to the document, the control unit 101 does not complete the creation of the document. That is, the control unit 101 does not store the document created by the creator into the storage unit 102 unless the password is set.

Here, with respect to the document program, although setting of a password to a document created by using the input unit 103 is described, no limitation is made to this. For example, it can be applied to a case where setting of a password is requested for electric data of a document read by the scanner of the MFP.

Before completing the creation of the document, the control unit 101 requests two kinds of passwords, that is, Owner Pass and Guest Pass as shown in FIG. 5. Accordingly, unless the creator inputs both the passwords of Owner Pass and Guest Pass, the creation of the document is not completed. Here, although the input of the two kinds of passwords of Owner Pass and Guest Pass is requested, either one of them or an additional password may be requested.

The Owner Pass is a password without operation restriction and enables the user knowing the Owner Pass to perform all operations on the document. That is, when the user acquires the document to which the password is set, and inputs, as the password, the Owner Pass set to the document by the document creating apparatus, the user can perform all operations, such as reading and editing, on the document.

The Guest Pass is a password with operation restriction which enables the user knowing the Guest Pass to perform some operations. That is, when the user acquires the document to which the password is set, and inputs, as the password, the Guest Pass set to the document by the document creating apparatus, the user can perform, for example, only reading of the document, and can not perform editing.

When the user knowing neither the Owner Pass nor Guest Pass acquires the document to which the password is set, since the document is not displayed on the display unit 105, the user can not read the document. Accordingly, according to the properties of the document, such as usage, importance and secrecy, the creator classifies users into a user who is informed of Owner Pass, a user who is informed of Guest Pass, and a user who is informed of nothing, and can keep the security of the document.

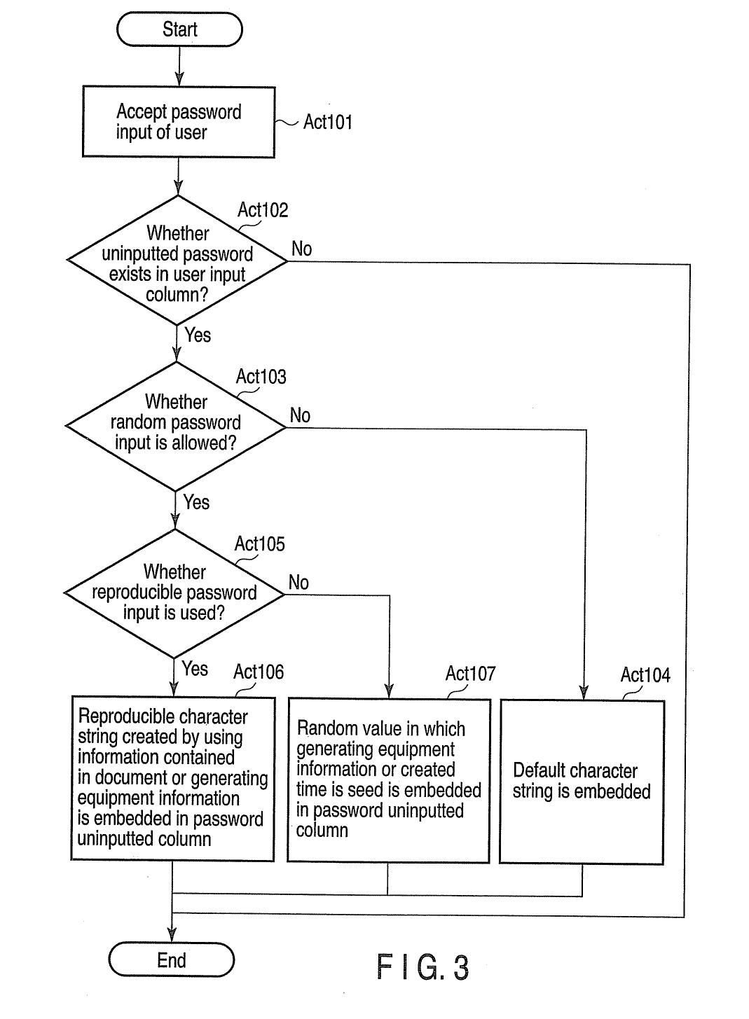

FIG. 3 is a flowchart for explaining the password setting in the document creating apparatus of the embodiment. First, the control unit 101 requests input of a password to a document. As shown in FIG. 5, the control unit 101 displays a screen of a password input column on the display unit 105, and receives the input of the password by the creator (Act 101).

The control unit 101 determines whether or not the password is inputted in the password input column (Act 102). When the password is inputted in the password input column (Act 102, NO), the control unit 101 ends the setting process of the password to the document.

When the password is not inputted in the password input column (Act 102, YES), the control unit 101 determines whether or not input of a random password into the password input column is allowed (Act 103). The control unit 101 functions as a determination unit.

The random password is a random character string which is neither a password inputted by the creator nor a default character string set by the control unit 101. The creator can previously set so that when the control unit 101 determines that the input of the password is cancelled, the random password is inputted into the password input column. The creator may previously set so that when the control unit 101 determines that the input of the password is cancelled, a selection screen as to whether or not the random password is allowed is displayed on the display unit 105. The control unit 101 changes the character string set as the password to the default character string or the random character string according to whether or not the random password can be allowed. The control unit 101 functions as a change unit.

When the input of the random password into the password input column is not allowed (Act 103, NO), the control unit 101 sets the default character string as the password into the password input column (Act 104). The control unit 101 functions as the setting unit. Thereafter, the control unit 101 ends the setting process of the password to the document. The default character string is a simple one such as consecutive identical numerals or characters.

When the input of the random password into the password input column is allowed (Act 103, YES), the control unit 101 determines whether or not the use of a reproducible character string as a random password is set in the password input column (Act 105).

Here, the reproducible character string uses information contained in the document or information of the document creating apparatus itself such as the serial number. Accordingly, although the reproducible character string is not simple as compared with the default character string, it is information which can be easily known by the creator.

The creator cancels the input of the password by the creator himself/herself in the state where the password input column is displayed on the display unit 105, and when the random password is allowed, the creator uses the input unit 103 and can set whether or not the reproducible character string can be used, so that the control unit 101 starts a process to set an arbitrary reproducible character string.

When the control unit 101 determines that the input of the password is cancelled and the random password is allowed, the creator can previously set to input the reproducible character string in the password input column. When the control unit 101 determines that the input of the password is cancelled, and the random password is allowed, the creator may display, on the display unit 105, a selection screen as to whether or not the reproducible character string can be inputted. The control unit 101 changes the character string set as the password according to whether or not the reproducible character string can be inputted.

When the reproducible character string can be used (Act 105, YES), the control unit 101 sets the reproducible character string into the password input column (Act 106). The control unit 101 sets, as the password, the reproducible character string different for each document. And then, the control unit 101 ends the setting process of the password to the document.

When the reproducible character string can not be used (Act 105, NO), the control unit 101 sets a character string of a random number as a password into the password input column (Act 106). Thereafter, the control unit 101 ends the setting process of the password to the document. Here, the character string of the random number is a value based on information of the document creating apparatus itself such as the serial number, the creation time of the document, or the like. The control unit 101 sets, as the password, the character string of the random number different for each document.

As stated above, the setting of the password to the document is ended. The creator can store the document in the document management server on the network through the communication I/F 107. The user can acquire the document stored in the document management server on the network through the communication I/F 107 into the document creating apparatus through the communication I/F 107, and can store it in the storage unit 102.

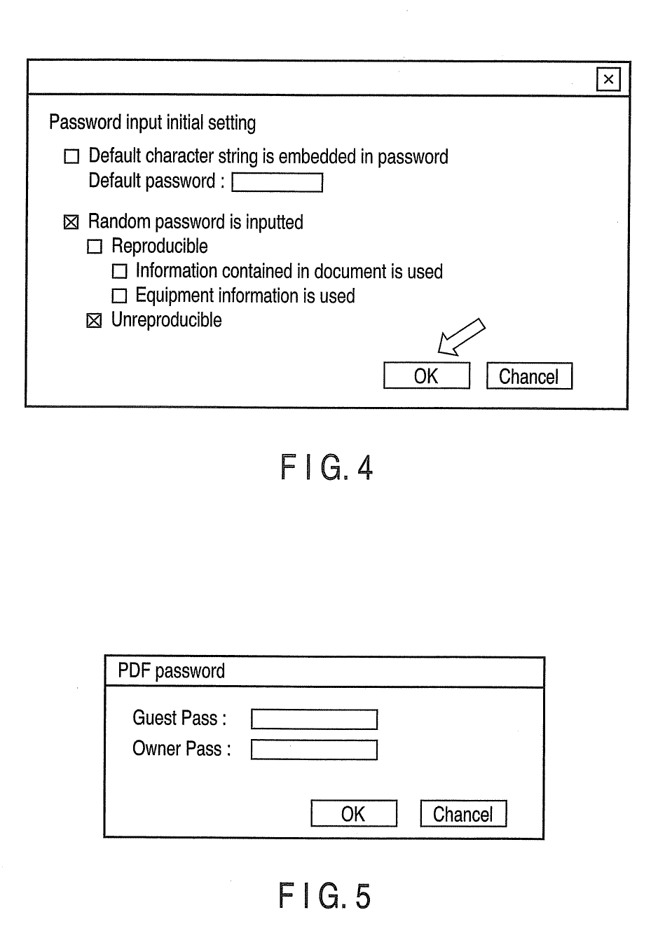

FIG. 4 is a password input initial setting screen displayed on the display unit 105 of the document creating apparatus of the embodiment. The password input initial setting is previously set before the user using the document creating apparatus creates the document. It is alternatively selected whether the default password is set or the random password is set. When the random password is checked, it is selected whether the password is reproducible or not. When the password is reproducible, it is selected whether the use information is contained in the document or relates to the equipment. Incidentally, this set value is stored as the initial value in the storage unit 102 of the document creating apparatus.

On the other hand, when the user who acquires the document inputs the display of the document by the input unit 103 to the display unit 105, before displaying the document, the control unit 101 displays the screen requesting the input of the password on the display unit 105. When the user inputs the Owner Pass as the password, the control unit 101 displays the document on the display unit 105 in the state where the operation restriction is not imposed. When the user inputs the Guest Pass as the password, the control unit 101 displays the document on the display unit 105 in the state where operation restriction is imposed. When the user does not input a password, the control unit 101 does not display the document on the display unit 105.

When the creator of the document sets a simple password as the Owner Pass or Guest Pass, and when the document creating apparatus itself sets the default character string as the Owner Pass or Guest Pass, there increases a possibility that a third person can easily infer the Owner Pass or Guest Pass. The danger of leakage of the document increases and this is not desirable in security.

Further, when the creator never edit the document again, since it is not necessary to set the Owner Pass at the time of document creation, the setting of the password becomes troublesome. Similarly, when the document is not circulated among persons other than the creator, since it is not necessary to set the Guest Pass at the time of document creation, the setting of the password becomes troublesome.

In this embodiment, since the document creating apparatus itself proposes a character string as a password which is hard for a third person other than the creator to infer, it is possible to reduce the labor of setting a redundant password each time the creator creates the document. Further, the creator determines the properties of the document and can previously set that the character string of the password set by the document creating apparatus itself is determined by what method. Accordingly, in this embodiment, safer management and operation of documents is enabled in the document creating apparatus and on the network connected thereto.

When allowing the input of the random password at Act 103 of FIG. 2, the control unit 101 may set the reproducible character string as the password as in Act 106 without determining whether or not the reproducible character string is used at Act 105. Similarly, the control unit 101 may set the character string of the random number as the password as in Act 107 without determining whether or not the reproducible character string is used at Act 105.

Before setting the password at Act 104, Act 106 or Act 107, the control unit 101 may display a character string as a recommendation value on the display unit 105. The user sees the recommendation value and can confirm the password. When the user changes the password to a character string other than the recommendation value, the user may use the input unit 103 to input resetting of a new character string as a password. The creator uses the input unit 103 to edit the recommendation value, and may set a new character string as a password.

When setting the password at Act 104, Act 106 or Act 107, the control unit 101 uses only characters which can be inputted by the document creating apparatus in accordance with the specification of the document creating program. Further, the control unit 101 can restrict the number of characters (n characters or more, m characters or less) of the password set at Act 104, Act 106 or Act 107, or the kinds of characters (capital letter, small letter, symbol character) used as the password, and well-known character strings by previously using the input unit 103. The creator can take measures against password crack.

When the user having the right on a specific document uses the input unit 103 to input a specified code, the control unit 101 reads the password set to the specific document, which is recorded in the storage unit 102 of the document creating apparatus or the document management server, and can display it on the display unit 105.

Although the description is given to the personal computer as an example of the document creating apparatus of the embodiment, a document management apparatus having the same function may be adopted. Further, an image storage apparatus having a scanner may be adopted.

What is claimed is:

1. A document creating apparatus comprising:
a creation unit configured to create electric data;
a request unit configured to request an input of a password to the electric data created by the creation unit;
a determination unit configured to determine presence or absence of the input of the password according to the request unit; and
a setting unit configured to set an arbitrary character string as the password when the determination unit determines that the password is not inputted.

2. The apparatus of claim 1, comprising:
an input unit configured to input the password in accordance with a request of the request unit.

3. The apparatus of claim 1, comprising:
a display unit configured to display the arbitrary character string as a recommendation value before it is set as the password.

4. The apparatus of claim 3, wherein the setting unit sets a new character string as the password based on an input of change of the recommendation value.

5. The apparatus of claim 1, wherein the request unit requires a password without function restriction as to the electric data and a password with function restriction as to the electric data.

6. The apparatus of claim 1, comprising:
a change unit configured to change the arbitrary character string set by the setting unit to a default character string or a random character string.

7. The apparatus of claim 6, wherein the change unit changes the random character string to a random number character string.

8. The apparatus of claim 6, wherein the setting unit uses information intrinsic to the document creating apparatus as the random character string.

9. The apparatus of claim 1, comprising:
a display unit configured to display the password based on an input of a display request of the password set to the electric data.

10. The apparatus of claim 1, wherein
the setting unit performs setting based on an input of restriction of character strings usable as the arbitrary character string.

11. A program used for a document creating apparatus, comprising:
a function to request an input of a password to electric data;
a function to determine presence or absence of the input of the password; and
a function to set an arbitrary character string as the password when it is determined that the password is not inputted.

12. The program of claim 11, comprising:
a function to display the arbitrary character string as a recommendation value before it is set as the password.

13. The program of claim 12, comprising:
a function to set a new character string as the password based on an input of change of the recommendation value.

14. The program of claim 11, comprising:
a function to request a password without function restriction as to the electric data and a password with function restriction as to the electric data.

15. The program of claim 11, comprising:
a function to change the arbitrary character string to a default character string or a random character string.

16. The program of claim 15, comprising:
a function to change the random character string to a random number character string.

17. The program of claim 15, comprising:
a function to use information intrinsic to the document creating apparatus as the random character string.

18. The program of claim 11, comprising:
a function to display and control the password based on an input of a display request of the password set to the electric data.

19. The program of claim 11, comprising:
a function to change the arbitrary character string to a usable character string according to setting.

20. A document creating method comprising:
creating electric data;
requesting an input of a password to the electric data;
determining presence or absence of the input of the password; and
setting an arbitrary character string as the password when the password is not inputted.
